(19) United States
(12) Patent Application Publication
(10) Pub. No.: US 2024/0339830 A1
(43) Pub. Date: Oct. 10, 2024

(54) DQ Admittance Model Extraction System add Method via Gaussian Pulse Excitation

(71) Applicant: University of South Florida, Tampa, FL (US)

(72) Inventors: Lingling Fan, Tampa, FL (US); Zhixin Miao, Tampa, FL (US)

(21) Appl. No.: 18/628,249

(22) Filed: Apr. 5, 2024

Related U.S. Application Data
(60) Provisional application No. 63/494,459, filed on Apr. 5, 2023.

(51) Int. Cl. H02J 3/00

(52) U.S. Cl. CPC H02J 3/001; H02J 2203/20

(57) ABSTRACT

An exemplary system and method are disclosed that employ dq admittance extraction or identification based on Gaussian time-domain pulse excitation. A narrow time-domain pulse has a wide frequency spectrum. Two or more narrow time-domain pulses can be injected, as simulated transients, into a utility infrastructure with one or multiple inverter-based resources to perturb the system with a wide frequency spectrum that overs the frequencies of interest.

### RELATED APPLICATION

This application claims priority to, and the benefit of, U.S. Provisional Patent Application No. 63/494,459, filed Apr. 5, 2023, which is incorporated by reference herein in its entirety.

### GOVERNMENT LICENSE RIGHTS

This invention was made with government support under DE-EE 0008771 awarded by the United States Department of Energy. The government has certain rights in the invention.

### BACKGROUND

Today's electricity grids are facing new stability problems with the introduction of renewable generation equipment, such as wind and solar generation equipment, and their corresponding inverter-based resources. Different manufacturers of inverter-based resources often employ different control strategy that that are proprietary and not shared with the utilities or academics. The multiple systems can operate together and exhibit complex dynamics for a given power production site, e.g., wind farm, solar farm, and the like.

Dq admittance model identification, as gray-box model identification, is useful for the stability analysis of complex utility systems. In general, the dq transform can reduce three AC quantities to two DC quantities in the case of balanced three-phase circuits to which calculations can be solved via more straightforward equations in DC quantities and then inverse transformed to bring back to AC results. Extracting admittance models of inverter-based resources (IBRs) using frequency scans can take time, often requiring multiples (e.g., hundreds) of experiments, each with a sinusoidal perturbation with a given frequency injected into an input portal and the measurements of the output portals are recorded and processed to extract the phasor of the harmonic component. Multitone sinusoidal or chirp signal injection has been shown to speed up experiments.

There is a benefit to improving the dq admittance model identification of utility infrastructure having gray-box inverter-based resources.

### SUMMARY

An exemplary system and method are disclosed that employ dq admittance extraction or identification based on Gaussian time-domain pulse excitation. A narrow time-domain pulse has a wide frequency spectrum. Two or a few narrow time-domain pulses can be injected, as simulated transients, into a utility infrastructure with one or multiple inverter-based resources to perturb the system with a wide frequency spectrum that overs the frequencies of interest. Gaussian time-domain pulses are smooth in both the time domain and frequency domain, providing (i) numerical advantages in input/output model identification relying on algorithms of subspace methods and optimization and (ii) with a narrow width (in time) can capture dynamics over a wide frequency range of interest. Notably, the exemplary system and method can produce a parametric low-order linear model that is suitable for stability analysis.

As used herein, the terms “extraction” and “identifcation” are interchangeably used and refer to inferring models from data.

In an aspect, a system (e.g., analysis system) is disclosed comprising a processor; and a memory having instructions stored thereon, wherein execution of the instructions by the processor causes the processor to: receive measurement data acquired in response to an application of a Gaussian pulse excitation signal to a power distribution network by a piece of instrumentation equipment, wherein the power distribution network is coupled to one or more operating inverter equipment; and determine (e.g., via a continuous-time transfer function analysis) a dq admittance parametric model for the power distribution network using the measurement data, wherein the dq admittance parametric model is employed as an indication of system stability, or in a system stability analysis, for the power distribution network and its downstream load or power generating equipment, including the one or more operating inverter equipment.

In some embodiments, the Gaussian pulse excitation signal has a power level of at least 5 percent (e.g., between 5% and 50%) of a nominal voltage magnitude of the power distribution network at a point of the application of the Gaussian pulse excitation signal (e.g., without introducing non-linearity or saturation in the measurement).

In some embodiments, the Gaussian pulse excitation signal is treated as a transient by components in the power distribution network (e.g., wherein the indication of system stability is determined without other knowledge about controls and operations of the power distribution network).

In some embodiments, the execution of the instructions by the processor further causes the processor to output the dq admittance parametric model in a graphical user interface or report to be made accessible for the system stability analysis.

In some embodiments, the applied Gaussian pulse excitation signal has a perturbation frequency of at least between 1 Hz and 100 Hz.

In some embodiments, the dq admittance parametric model is generated in real-time in response to a real-time application of a Gaussian pulse excitation signal to a power distribution network.

In some embodiments, the dq admittance parametric model is generated for non-real-time post-analysis assessment of the power distribution network.

In some embodiments, the measurement data includes a response to an application of a single Gaussian pulse excitation signal to the power distribution network.

In some embodiments, an inverter of a wind turbine is a part of the power distribution network.

In some embodiments, the dq admittance parametric model is generated via a continuous-time transfer function analysis.

In some embodiments, the system includes the instrumentation equipment, wherein the processor and memory are part of the same.

In another aspect, a method is disclosed comprising receiving, by a processor, measurement data acquired in response to an application of a Gaussian pulse excitation signal to a power distribution network by a piece of instrumentation equipment, wherein the power distribution network is coupled to one or more operating inverter equipment; and determining, by the processor, a dq admittance parametric model for the power distribution network using the measurement data, wherein the dq admittance parametric model is employed as an indication of system stability, or in a system stability analysis, for the power distribution network and its downstream load or power generating equipment, including the one or more operating inverter equipment.

In some embodiments, the Gaussian pulse excitation signal has a power level of at least 5 percent (e.g., between 5% and 50%) of a nominal voltage magnitude of the power distribution network at a point of the application of the Gaussian pulse excitation signal (e.g., without introducing non-linearity or saturation in the measurement).

In some embodiments, the Gaussian pulse excitation signal is treated as a transient by components in the power distribution network (e.g., wherein the indication of system stability is determined without other knowledge about controls and operations of the power distribution network).

In some embodiments, the method further inlcudes outputting the dq admittance parametric model in a graphical user interface or report to be made accessible for the system stability analysis.

In some embodiments, the applied Gaussian pulse excitation signal has a perturbation frequency of at least between 1 Hz and 100 Hz.

In some embodiments, the dq admittance parametric model is generated in real-time in response to a real-time application of a Gaussian pulse excitation signal to a power distribution network.

In some embodiments, the dq admittance parametric model is generated for non-real-time post-analysis assessment of the power distribution network.

In some embodiments, the dq admittance parametric model is generated via a continuous-time transfer function analysis.

In another aspect, a non-transitory computer-readable medium is disclosed having instructions stored thereon, wherein execution of the instructions by the processor causes the processor to receive measurement data acquired in response to an application of a Gaussian pulse excitation signal to a power distribution network by a piece of instrumentation equipment, wherein the power distribution network is coupled to one or more operating inverter equipment; and determine (e.g., via a continuous-time transfer function analysis) a dq admittance parametric model for the power distribution network using the measurement data; wherein the dq admittance parametric model is employed as an indication of system stability, or in a system stability analysis, for the power distribution network and its downstream load or power generating equipment, including the one or more operating inverter equipment.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 shows an example system configured to perform dq admittance extraction or identification based on Gaussian time-domain pulse excitation, in accordance with an illustrative embodiment.

FIGS. 2A and 2B each show additional example systems configured to perform dq admittance extraction or identification based on Gaussian time-domain pulse excitation, in accordance with an illustrative embodiment.

FIG. 3 shows an example method of performing dq admittance extraction or identification based on Gaussian time-domain pulse excitation in accordance with an illustrative embodiment.

FIG. 4A shows an example Gaussian pulse in the time domain and in the frequency domain.

FIG. 4B shows an example injected Gaussian perturbation for dq admittance extraction or identification based on Gaussian time-domain pulse excitation in accordance with an illustrative embodiment.

FIG. 5A shows a measurement testbed for a type-4 wind turbine, with the turbine connected to a controllable three-phase voltage source.

FIG. 5B shows an example parametric model having a frequency response of a dq admittance model generated using Gaussian time-domain pulse excitation.

FIG. 5C shows an example comparative parametric model having a frequency response of a dq admittance model generated using chirp signal injection.

FIG. 5D shows a comparison of the simulated responses of parametric model m1 and m2 for a Gaussian pulse scan and a chirp signals frequency scan against measured data in a study.

FIG. 5E shows comparative results of q-axis voltage being perturbed by a Gaussian pulse of 0.5 p.u. and by a chirp signals frequency scan.

FIG. 6A shows a measurement test bed setup used to acquire measurement results in the study.

FIG. 6B shows a photo of the controllable grid interface of the measurement test bed set up and example hardware for medium voltage sensors.

### DETAILED SPECIFICATION

To facilitate an understanding of the principles and features of various embodiments of the present invention, they are explained hereinafter with reference to their implementation in illustrative embodiments.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entirety and to the same extent as if each reference was individually incorporated by reference.

### Example System

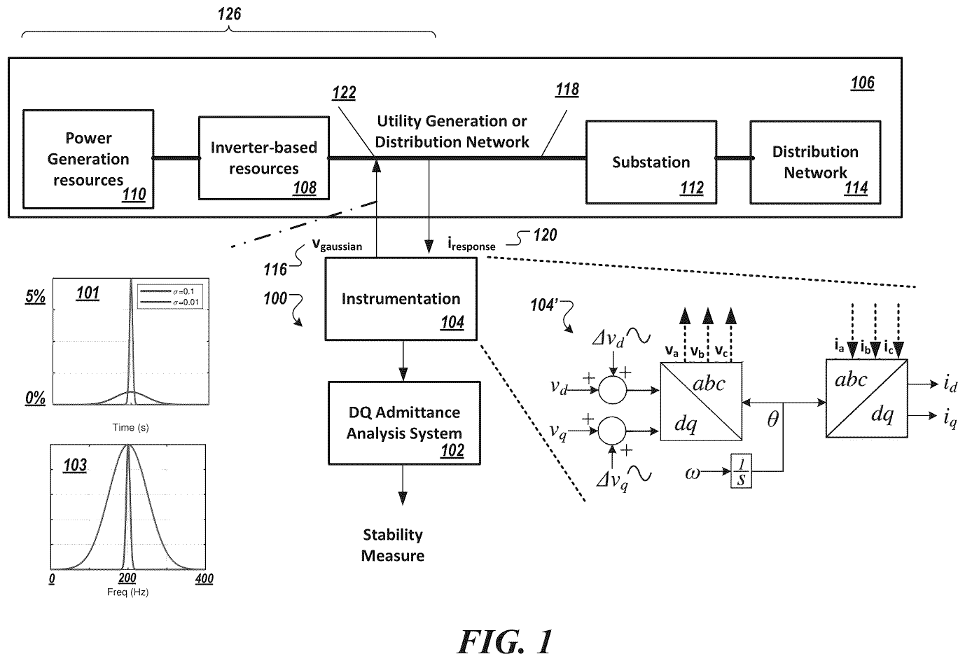

FIG. 1 shows an example system 100 configured to perform dq admittance extraction or identification based on Gaussian time-domain pulse excitation 101. In the example shown in FIG. 1, system 100 includes a DQ admittance analysis system 102 that operates with instrumentation 104 to perturb a utility infrastructure 106 having inverter-based resources 108. In the example shown in FIG. 1, the inverter-based resources 108 are coupled to power generation resources 110 (e.g., wind turbine, photovoltaic panels, fuel cell, batteries, or other associated equipment). The utility infrastructure 106 also couples to substation 112 coupled to a distribution network 114.

In the example shown in FIG. 1, the instrumentation 104 is configured to (i) inject a voltage 116 (shown as “V_{gaussian}” 116) (e.g., 3-phase voltage) comprising a Gaussian-shaped signal 101 (or three Gaussian-shaped signals for 3-phase) as a transient into a bus 118 of the power system network and (ii) measure a corresponding response as a current measurement 120 (shown as “iᵣₑₛₚₒₙₛₑ” 120) (e.g., 3-phase). The instrumentation 104 can also record or save the injected voltage 116 for the subsequent model identification analysis. The instrumentation 104 can be high-power converters or medium voltage sensors. Medium voltage generally refers to voltages between 2,400 VAC and 69,000 VAC. The Gaussian pulse excitation signal 101 has a perturbation frequency 103 of at least between 1 Hz and 100 Hz, e.g., about 100 Hz bandwidth, over a central frequency, e.g., 50 Hz. The plot 103 shows a frequency distribution of 400 Hz over a 200 Hz center frequency. To avoid introducing non-linearity or saturation into the measurement, the Gaussian pulse excitation signal 101 may have a power level of at least 5 percent, e.g., between 5% and 50%) of a nominal voltage magnitude of the power distribution network at a point 122 of the application of a Gaussian pulse excitation signal 101. The Gaussian pulse excitation signal 101 can be at a level comparable to a transient introduced by components in the power distribution network 118.

The time-domain expression of a Gaussian pulse and its Fourier transform can be expressed per Equations 1 and 2.

$$g ( t ) = \frac{1}{\sqrt{2 π} σ} {e}^{- \frac{{t}^{2}}{2 {σ}^{2}}} \qquad ( Eq . 1 )$$

$$G ( f ) = {e}^{- \frac{1}{2} {( 2 πσ f )}^{2}} \qquad ( Eq . 2 )$$

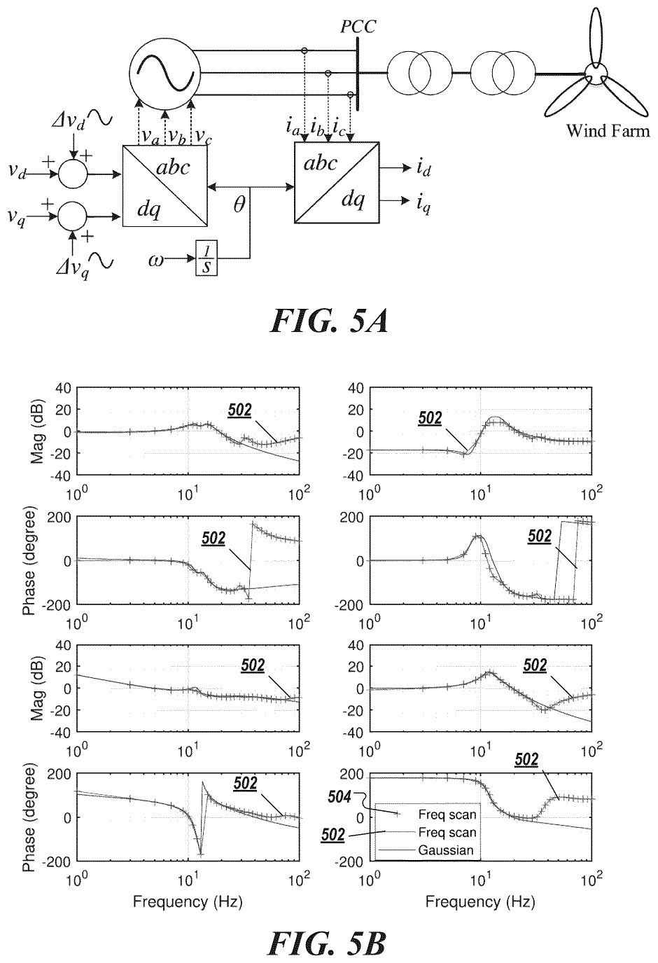

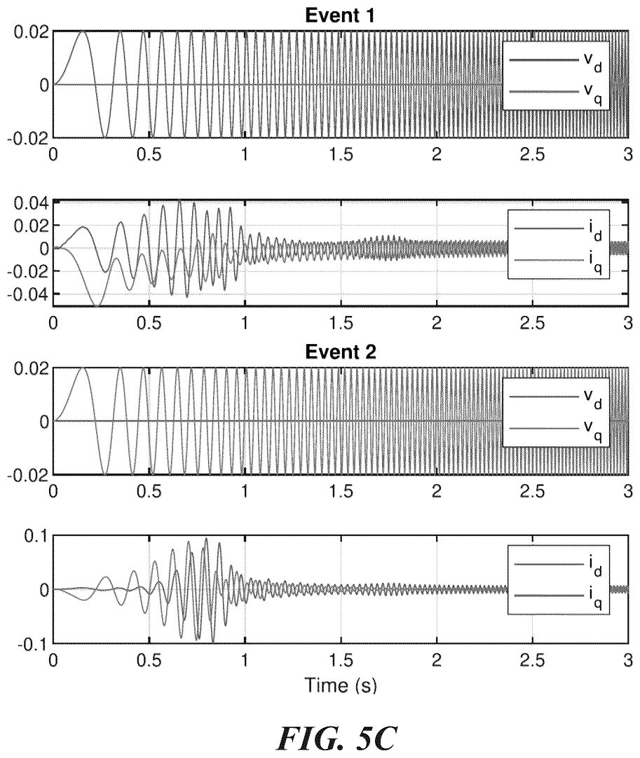

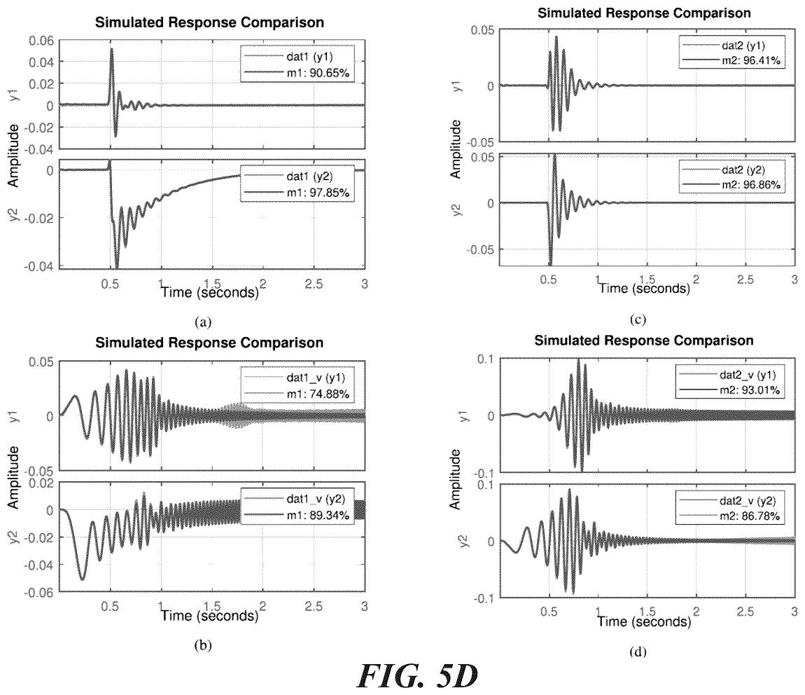

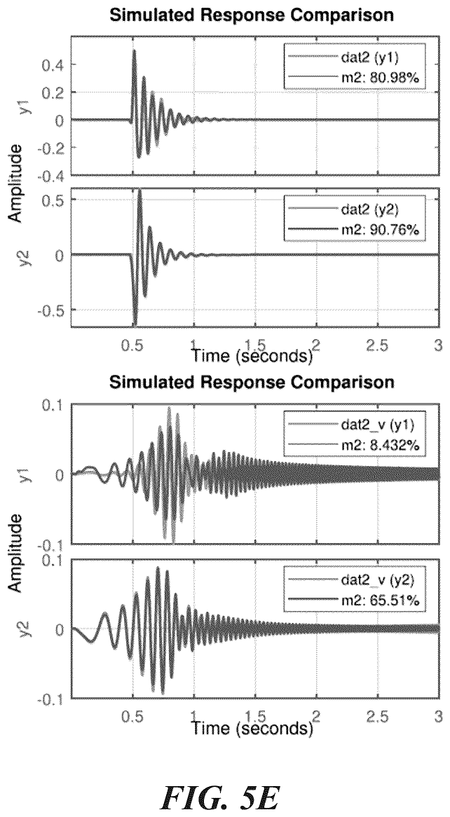

The analysis system 102 can receive the measurement data acquired in response to an application of a Gaussian pulse excitation signal 116 to the power distribution network 118 and determine a dq admittance parametric model 124 (not shown, see FIG. 5B) for the power distribution network 118. The dq admittance parametric model 124 can be employed as an indication of system stability or employed in a system stability analysis for the power distribution network and its downstream load or power generating equipment (e.g., 126), including one or more pieces of operating inverter equipment. Notably, the indication of system stability is determined as a gray-box model without other knowledge about the controls and operations of the power distribution network. To this end, utilities can assess their power system without or with minimal knowledge of the inverter-based resources as provided by the resource manufacturer or for complex power system networks.

The dq admittance parametric model may be generated in real-time in response to a real-time application of a Gaussian pulse excitation signal to a power distribution network. The dq admittance parametric model may be generated for non-real-time post-analysis assessment of the power distribution network. In some embodiments, the dq admittance parametric model is displayed in a graphical user interface or report to be made accessible for the system stability analysis.

In the example shown in FIG. 1, instrumentation 104 (shown as 104′) is configured to introduce two perturbation voltages superimposed into the voltage source, respectively. The voltages are defined in the dq-frame and converted to the abc-frame to form a three-phase voltage perturbation. The resulting responses are recorded as current measurements at bus 118 by the instrumentation 104′ and are converted to dq-frame variables, i_{dq}. Fast Fourier transform (FFT) may be implemented to extract the phasor form of v_{dq} and i_{dq} at the frequency of the injected perturbation. The injected Gaussian perturbation may be sufficiently small to not influence the system operation.

The dq-transform can be expressed by Equation Set 3 with Vq and Vd being voltages defined in the dq-frame to generate the Gaussian pulse excitation 101 in the time domain.

$$[ \begin{matrix}{V}_{a} ( t ) \\ {V}_{b} ( t ) \\ {V}_{c} ( t )\end{matrix} ] = [ \begin{matrix}cos θ & - sin θ \\ cos ( θ - \frac{2 π}{3} ) & - sin ( θ - \frac{2 π}{3} ) \\ cos ( θ + \frac{2 π}{3} ) & - sin ( θ + \frac{2 π}{3} )\end{matrix} ] [ \begin{matrix}{V}_{d} ( t ) \\ {V}_{q} ( t )\end{matrix} ] \\ [ \begin{matrix}{I}_{d} ( t ) \\ {I}_{q} ( t )\end{matrix} ] = \frac{2}{3} [ \begin{matrix}cos θ & cos ( θ - \frac{2 π}{3} ) & cos ( θ + \frac{2 π}{3} ) \\ - sin θ & - sin ( θ - \frac{2 π}{3} ) & - sin ( θ + \frac{2 π}{3} )\end{matrix} ] [ \begin{matrix}{I}_{a} ( t ) \\ {I}_{b} ( t ) \\ {I}_{c} ( t )\end{matrix} ] \qquad ( Eq . Set 3 )$$

The Gaussian pulse dq-frame to generate the two Gaussian pulse excitation signals 101 (as events “1” and “2”). Event 1 is d-axis voltage perturbation and Event 2 is q-axis voltage perturbation.

The DQ admittance analysis system 102 is configured to (i) receive the current recordings and Gaussian pulse excitation signals 101 from the instrumentation 104 and (ii) analyze the recording to determine a parametric low-order linear model of the power distribution network and its downstream load or power generating equipment (e.g., 126). The input and output data may have a sampling rate of 10 KHz.

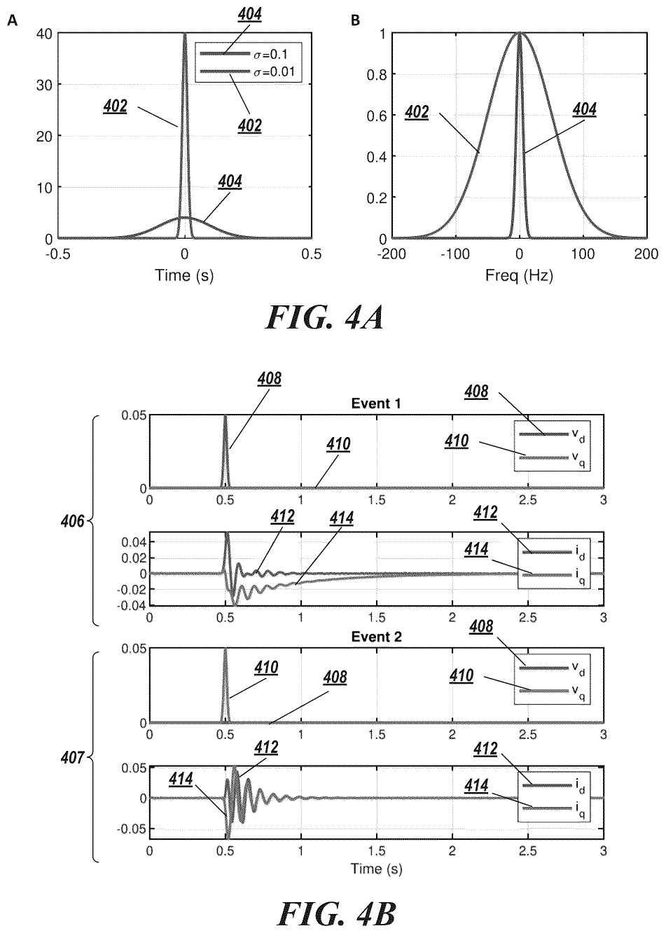

FIG. 4B shows an example injected Gaussian perturbation. In FIG. 4B, a first measurement (406) is performed in which a d-axis voltage perturbation (408) is introduced to the 3-phases of a power system (note, a “0” voltage is applied to the q-axis voltage perturbation (410) to which a d-axis current response (412) and a q-axis current response (414) can be observed from a three-phase measurement. A second measurement (407) is then performed in which a q-axis voltage perturbation (410) is introduced to the 3-phases of a power system (while a “0” voltage is applied to the d-axis voltage perturbation (408) to which a d-axis current response (412) and a q-axis current response (414) can be observed from a three-phase measurement.

The DQ admittance analysis system 102 can estimate the dq admittance as a two-input, two-output system with the dq admittance relating the currents flowing into the IBR with the injection voltage per Equation 4.

$$[ \begin{matrix}{i}_{d} ( s ) \\ {i}_{q} ( s )\end{matrix} ] = [ \begin{matrix}{Y}_{dd} ( s ) & {Y}_{dq} ( s ) \\ {Y}_{qd} ( s ) & {Y}_{qq} ( s )\end{matrix} ] [ \begin{matrix}{v}_{d} ( s ) \\ {v}_{q} ( s )\end{matrix} ] \\ Y = [ \begin{matrix}{Y}_{dd} ( s ) & {Y}_{dq} ( s ) \\ {Y}_{qd} ( s ) & {Y}_{qq} ( s )\end{matrix} ] \qquad ( Eq . 4 )$$

The desired admittance is a 2-by-2 matrix describing the input/output relationship between dq currents and dq voltages. To generate the matrix, the analysis can be performed for a column (2-by-1) at a time. As described above, d-axis voltage can be first perturbed and id and iq recorded. This can provide the first column of Y, i.e., m1. Then, the q-axis voltage is perturbed, and id and iq are recorded to provide the second column of Y, i.e., m2.

With the two sets of event data, DQ admittance analysis system 102 can estimate two models, m₁ and m₂, for example, using a least square estimation such as the Instrumental Variables (IV) method. The transfer function m₁ can be based on (i) i_{d}(s) and v_{d}(s) and (ii) i_{q}(s) and v_{d}(s), per Equation 5, and m₂ can be based on (i) i_{d}(s) and v_{q}(s) and (ii) i_{q}(s) and v_{q}(s). The IV method can mitigate the effect of biased error in the least square estimation.

$${m}_{1} = [ \begin{matrix}{Y}_{dd} ( s ) \\ {Y}_{qd} ( s )\end{matrix} ] , {m}_{2} = [ \begin{matrix}{Y}_{dq} ( s ) \\ {Y}_{qq} ( s )\end{matrix} ] , Y = [ \begin{matrix}{m}_{1} & {m}_{2}\end{matrix} ] \qquad ( Eq . 5 )$$

Indeed, the DQ admittance analysis system 102 can determine a Dq admittance model as a gray-box model identification. The output can be a low-order linear parametric model having the form per Equation 5. An example of plots of the parametric model for Y_{dd}, Y_{dq}, Y_{qd}, or Y_{qq} is provided per FIG. 5B.

$$H ( {Z}^{- 1} ) = \frac{{b}_{1} {z}^{- 1} + {b}_{1} {z}^{- 2}}{1 + {a}_{1} {z}^{- 1} + {a}_{2} {z}^{- 2}} \qquad ( Eq . 6 )$$

Stability evaluations can be performed based on the parametric model, for example, an evaluation for critical damping or oscillation behaviors of the system and whether transients converge to a stable condition within a pre-defined transient envelope or time. The transient envelope may be defined by a utility for a given power system.

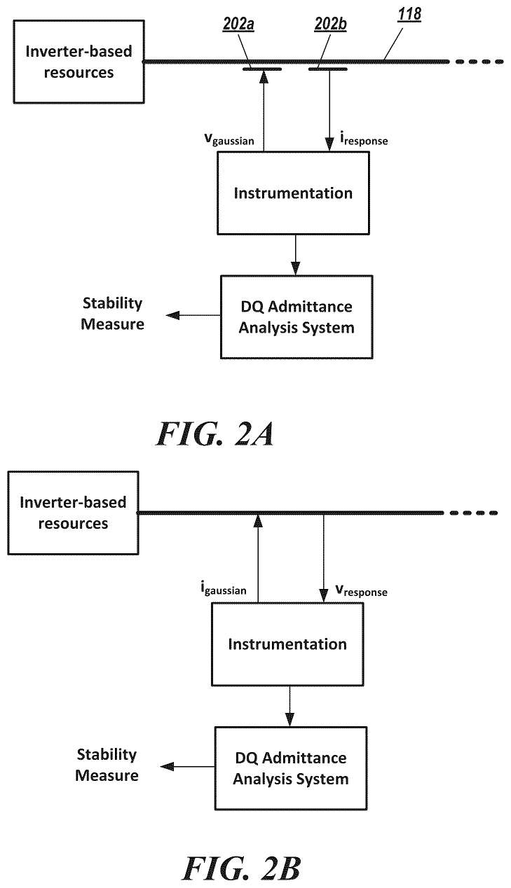

Additional system examples. FIGS. 2A and 2B each show additional example systems configured to perform dq admittance extraction or identification based on Gaussian time-domain pulse excitation, in accordance with an illustrative embodiment. In FIG. 2A, instrumentation 104 (shown as 104a) is configured to inject a voltage (e.g., 3-phase) and measure current (e.g., 3-phase) from the bus 118 through a non-contact sensor or probe 202 (shown as 202a, 202b). The voltage injection may be performed through a plate, coil, or transformer, capacitively or inductively coupled to the bus. The current measurement may be a non-contact current sensor, e.g., hall effect current sensor, current transformer, or magneto-resistive current sensor, among others described or referenced herein.

FIG. 2B shows another configuration of the systems configured to perform dq admittance extraction or identification based on Gaussian time-domain pulse excitation, in accordance with an illustrative embodiment. In FIG. 2B, the instrumentation is configured to inject a current at the Gaussian time-domain pulse excitation to the bus 118 and record a voltage as a response. Equation 5 can be modified accordingly for the system identification.

### Example Method

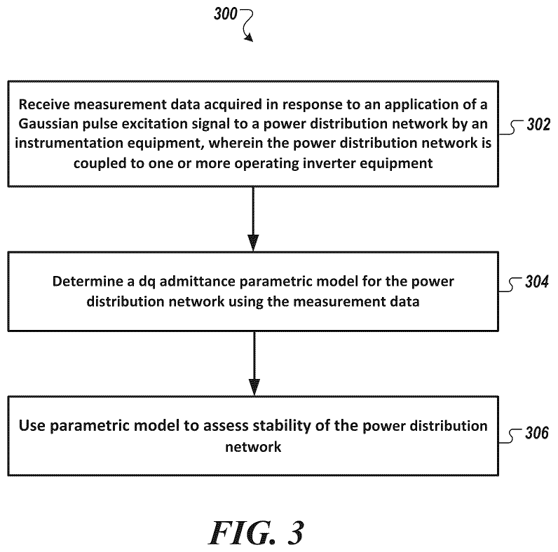

FIG. 3 shows an example method 300 of performing dq admittance extraction or identification based on Gaussian time-domain pulse excitation in accordance with an illustrative embodiment. Method 300 comprises receiving (302), by a processor, measurement data acquired in response to an application of a Gaussian pulse excitation signal to a power distribution network by an instrumentation equipment, wherein the power distribution network is coupled to one or more operating inverter equipment. Method 300 then includes determining (304), by the processor, a dq admittance parametric model for the power distribution network using the measurement data, wherein the dq admittance parametric model is employed as an indication of system stability, or in a system stability analysis, for the power distribution network and its downstream load or power generating equipment, including the one or more operating inverter equipment.

Measurements may be acquired at a sampling rate at least 10× of the frequency of interest. For example, for a 100 Hz frequency range, the measurement can acquire current or voltage measurements at 2 KHz, 3 KHz, 4 KHz, 5 KHz, 6 KHz, 7 KHz, 8 KHz, 9 KHz, 10 KHz, among others described or referenced herein.

In some embodiments, the Gaussian pulse excitation signal has a power level of at least 5 percent (e.g., between 5% and 50%) of a nominal voltage magnitude of the power distribution network at a point of the application of the Gaussian pulse excitation signal (e.g., without introducing non-linearity or saturation in the measurement). In some embodiments, the power level can be at 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50% of the nominal voltage magnitude of the power distribution network. For a medium voltage network, 2,400 VAC, 69,000 VAC, the power level of at least 5 percent would be at least 120 VAC. For 69,000 VAC medium voltage line, the power level of at least 5 percent would be about 3,450 VAC.

In some embodiments, the Gaussian pulse excitation signal is treated as a transient by components in the power distribution network (e.g., wherein the indication of system stability is determined without other knowledge about controls and operations of the power distribution network).

In some embodiments, the method includes outputting the dq admittance parametric model in a graphical user interface or report to be made accessible for the system stability analysis.

In some embodiments, the applied Gaussian pulse excitation signal has a perturbation frequency of at least between 1 Hz and 100 Hz. In some embodiments, the perturbation frequency is from 0.1 Hz to 100 Hz. In some embodiments, the perturbation frequency is 1 Hz to 120 Hz. In some embodiments, the perturbation frequency is 1 Hz to 180 Hz. In some embodiments, the perturbation frequency is 1 Hz to 240 Hz. In some embodiments, the perturbation frequency is 1 Hz to 480 Hz. In some embodiments, the perturbation frequency is 1 Hz to 1000 Hz.

In some embodiments, the dq admittance parametric model is generated in real-time in response to a real-time application of a Gaussian pulse excitation signal to a power distribution network.

In some embodiments, the dq admittance parametric model is generated for non-real-time post-analysis assessment of the power distribution network.

In some embodiments, the dq admittance parametric model is generated via a continuous-time transfer function analysis.

### Experimental Results and Additional Examples

A study was conducted to develop a new experiment data generation method to obtain the dq admittance of a black-box IBR based on Gaussian pulse excitation to create data. The input and output data are used for system identification, and the outcome is a parametric low-order linear model. The study developed three critical components of the method: experiment design, model identification, and model validation. The frequency response of the admittance identified was shown to be accurate up to the subsynchronous frequency range. It can be observed that the Gaussian pulse injection method is suitable for the estimation of dq admittance for the low frequency to subsynchronous frequency range.

Discussion. While dq admittance models have shown to be very useful for stability analysis (see, e.g., [1]), extracting admittance models of inverter-based resources (IBRs) from the electromagnetic transient (EMT) simulation environment using frequency scans can take time. The frequency scanning method may require hundreds of experiments. For each experiment, a sinusoidal perturbation with a given frequency is injected into an input portal and the measurements of the output portals are recorded and processed to extract the phasor of the harmonic component [2].

To speed up the process, alternative model extraction methods have been employed. In general, there are two categories of models that can be obtained from measurement data: non-parametric (Category 1) and parametric (Category 2) [3]. Non-parametric models can be time-domain impulse responses at discrete time points and frequency-domain responses at discrete frequency points. Frequency scans lead to non-parametric models. Parametric models include those expressed as transfer functions or state-space models. To obtain parametric models from non-parametric models, a data fitting procedure has to be carried out, as described in [4] or [5].

In Category 1, speeding up can be realized by the use of multitone sinusoidal or chirp signal injection followed by the cross-correlation analysis [6] or a pseudo-random binary signal (PRBS) injection followed by the cross-correlation analysis [7]. For better outcomes, PRBS injection usually repeats sequences several times. For example, in [8], five repetitions were observed to produce more accurate frequency responses from 0.06 to 10 rad/s with 200-s simulation data being used.

Compared to non-parametric models, parametric models have a unique advantage. They can be used directly for analysis and simulation. This feature also makes model validation very easy. After a model is obtained from a data set using Gaussian pulses, it can be used to simulate output responses for another data set. A high matching degree indicates the good quality of a model.

In Category 2, various system identification methods may be applied to extract input/output models. A dq admittance identification method was designed using subspace methods in [9]. The step response experiments were used to create two sets of output data, which were further converted to the Laplace domain expressions. Eventually, a dq admittance model in the Laplace domain was found. The method was also implemented to extract the dq admittance of a real-world 2.3-MW commercial battery inverter located in NREL's Flatiron campus [5]. However, experiment results show that the step response experiment requires to have large enough perturbation to create output data and differentiate noise and signals. The voltage perturbation applied needs to be at 10% of the nominal voltage magnitude. Such step excitation changed the system operating conditions; hence, impulse perturbations are preferred. An ideal impulse injection would be difficult to implement numerically.

The instant study contemplated using a Gaussian pulse to emulate an ideal impulse, as a Gaussian pulse does not have abrupt changes and has a continuous and smooth waveform. The study developed and evaluated a dq admittance extraction method based on Gaussian pulse excitation. Gaussian pulse excitation has been used in physics [10]. The time-domain expression of a Gaussian pulse and its Fourier transform is expressed per Equations 1 and 2, shown in FIG. 4A. In FIG. 4A, it can be observed that the Fourier transform of a Gaussian pulse in the time domain (panel A) is also a Gaussian pulse in the frequency domain (panel B). In Equation 1, σ determines the width of the time-domain pulse. A narrower time-domain pulse 402 covers a wider frequency spectrum 404, as shown in FIG. 4A. Gaussian pulses are smooth in both the time domain and frequency domain, leading to numerical advantages in input/output model identification relying on algorithms of subspace methods and optimization.

The study noted several benefits of the exemplary method based on Gaussian pulse injection, including (i) providing a very short measurement time for system dynamic evaluations as compared to frequency scan and (ii) providing an outcome that is a parametric model. The study evaluated/validated the exemplary method based on Gaussian pulse injection against chirp signal-generated data.

Impedance measurement is an active research area in the power electronics community. Research groups in the power electronics community have explored various excitation methods, including chirp excitation [6], PRBS excitation [7], and most recently, impulse excitation [11]. On the other hand, Gaussian pulse excitation has not been examined.

Dq Admittance of Type-4 Wind Turbine. The instant study evaluated dq admittance estimation for a type-4 wind turbine system. The system can be estimated as a two-input-two-output system, and the dq admittance relates the currents flowing into the IBR with the injection voltage per Equation 5 (reproduced below).

$$[ \begin{matrix}{i}_{d} ( s ) \\ {i}_{q} ( s )\end{matrix} ] = [ \begin{matrix}{Y}_{dd} ( s ) & {Y}_{dq} ( s ) \\ {Y}_{qd} ( s ) & {Y}_{qq} ( s )\end{matrix} ] [ \begin{matrix}{v}_{d} ( s ) \\ {v}_{q} ( s )\end{matrix} ] \\ Y = [ \begin{matrix}{Y}_{dd} ( s ) & {Y}_{dq} ( s ) \\ {Y}_{qd} ( s ) & {Y}_{qq} ( s )\end{matrix} ] \qquad ( Eq . 5 )$$

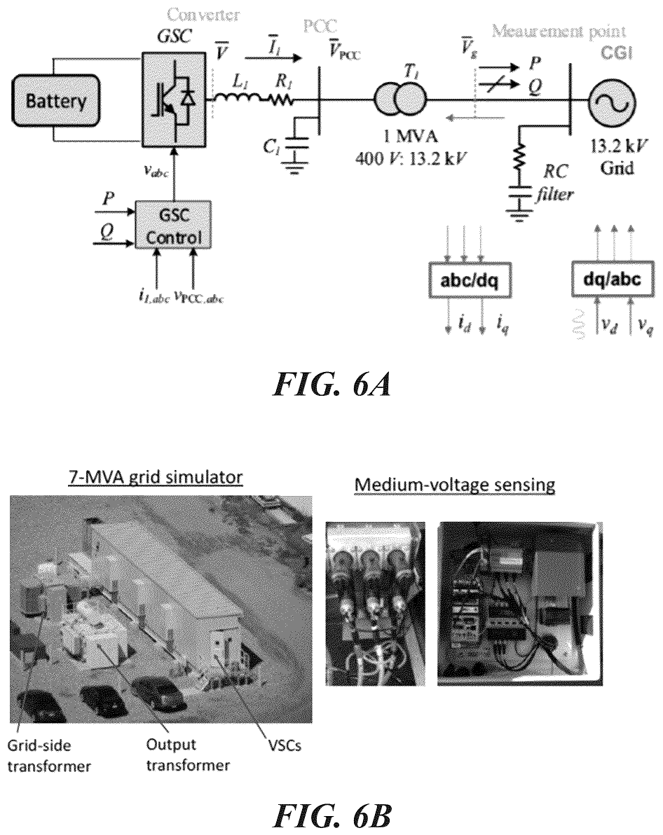

Frequency Scan Approach. The dq admittance, notated as Y (fi) (where fi is the perturbing frequency), may be measured via frequency scans. FIG. 5A shows a measurement testbed for a type-4 wind turbine, with the turbine connected to a controllable three-phase voltage source. The testbed is implemented in MATLAB/Simscape. The wind turbine included a permanent synchronous generator, a rectifier, a DC-DC boost converter, and a grid-side converter. The grid side converter is in the AC voltage and DC voltage control mode. FIG. 6A shows a measurement test bed set up at the National Renewable Energy Laboratory's Flatiron campus having a 7 MVA-13.2 kV controllable grid interface (CGI). The CGI can operate essentially as a grid-forming converter that can draw electricity from a utility grid and act as a controllable voltage source. When an IBR is connected through a step-up transformer to a CGI, it can be configured to operate at a certain operating condition. The CGI can produce a harmonic voltage source superimposed on its 60 Hz voltage source. This harmonic voltage source's frequency can vary. Thus, frequency scans can be conducted using CGI.

For the test bed, the model to be identified describes the relationship between the two inputs (the dq-axis voltages) and the two outputs (the dq-axis currents). This model is called dq admittance, and it is a two-by-two matrix in the Laplace domain. The four components of the dq admittance matrix are Ydd, Ydq, Yqd, and Yqq.

FIG. 6B, panel A shows a photo of the controllable grid interface, and FIG. 6B, panel B shows an example hardware for medium voltage sensors.

In the simulation, the d-axis of the voltage is first perturbed by a sinusoidal signal with 0.1 p.u. amplitude. The dq currents were then recorded. The measurement data was then processed to extract the Fourier coefficients at that frequency. The perturbation frequency varied from 1 Hz to 100 Hz. Next, the q-axis of the source voltage was perturbed, and a similar procedure was carried out. In total, 200 simulations are carried out.

The measurements from frequency scans were the most accurate among all the evaluated methods. This is due to the high signal to noise ratio of single-frequency injection signal. In FIG. 5B, each calculated dq admittance is shown at point 504; the total measuremnets are shown as line 502. The frequency-based dq admittance is additionally described in [12], and the admittance-based stability analysis results corroborate the EMT simulation results.

Gaussian Injection-Based Method. Using the same testbed of FIG. 5A, the study employed perturbation based on a Gaussian pulse with 0.01 width. The input (dq voltages) and the output (dq currents) were recorded and used for the analysis. FIG. 4B, previously discussed, shows an example of the simulation. For comparison, the study generated a set of validation data using chirp signal injection (from 0.1 Hz to 30 Hz), shown in FIG. 5C.

FIG. 4B shows that the magnitude of the pulse as 0.05. Event 1 is d-axis voltage perturbation and Event 2 is q-axis voltage perturbation. The input and output data had a sampling rate of 10 kHz. Based on the two sets of event data, the study identified two models, m1 and m2, as transfer functions using the tfest system identification toolbox of MATLAB. The tfest system identification employs Instrumental Variables (IV) method, a refined method that can mitigate the effect of biased error in the least square estimation [3]. Compared to the state-space model estimation function ssest, which uses the prediction error method (PEM), tfest was observed to provide better matching results compared to the validation data.

The study employed a model order as low as possible to avoid overfitting while providing a matching degree that is acceptable. The study started with a very low order and gradually increased the order to have an increased matching degree until increasing the order does not help in the matching degree. With the model order selected of 4 in the study, m1(s) and m2 (s) were calculated using inputs from Gaussian pulses and chirp signals. Other model order can be used and determined for the specific power network.

FIG. 5D shows a comparison of the simulated responses of m1 and m2 for the Gaussian pulse scan and the chirp signals frequency scans against measured data. Specifically, FIG. 5D, panel A shows a comparison of m1 model generated using simulated response of the system from Gaussian pulses against measured response of the system. FIG. 5D, panel B shows a comparison of m1 model generated using simulated response of the system from chirp pulse scans against measured response of the system. FIG. 5D, panel C shows a comparison of m2 model generated using simulated response of the system from Gaussian pulses against measured response of the system. FIG. 5D, panel D shows a comparison of m2 model generated using simulated response of the system from chirp pulse scans against measured response of the system. The percentage shown in the legend is the normalized root mean squared error (NRMSE) fitness value, representing the closeness of the determined parametric model output to the measurement data. In FIG. 5D, for both the Gaussian pulse scan data and the chirp signals frequency data, the models' outputs acceptably matched the measurement.

FIG. 5B shows the frequency response of the identified dq admittance. The response from the Gaussian pulse scan is compared with the discrete frequency response data obtained from Chirp frequency scans. It can be observed that the model's frequency response between the two approaches matched well for frequencies below 30 Hz.

While it may appear straightforward, care should be taken in the experiment design and data processing of the pulse injection measurement. A narrow width is preferable to provide a wider range of dynamics. The instant study used a width of 0.01 to capture dynamics up to 30 Hz. If a Gaussian pulse width of 0.1 was used, the excitation signal would include insignificant dynamics above 10 Hz and thus cannot produce output data with rich dynamics. Also, a suitable magnitude for the Gaussian pulse would have a maximum value of 5% of the nominal voltage to ensure the system is operating in a small disturbance range. A large Gaussian pulse may cause undesired nonlinearity in the system under study.

The study observed the Gaussian pulse measurement may be more robust than the chirp measurement with respect to excitation magnitude. At th FIG. 5E shows the q-axis voltage being perturbed by a Gaussian pulse of 0.5 p.u. is magnitude, the Gaussian pulse measurement appeared to provide a response matching the ground truth. However, when tested for the data generated by chirp signal injection at this magnitude, the matching degree was as low as 8%, indicating an inaccurate model.

### DISCUSSION

Reduced-order model identification for control design. Besides modeling, another category of application of measurement data is the development of a reduced-order dynamic model for control design. The control design problem could be to design a power system stabilizer for a synchronous generator's excitation system or a damping control for a flexible alternating current transmission system device.

For any control design problem, the plant model describing the input/output relationship is a necessity. Usually, a reduced-order plant model is desired. How do we find the plant model? The measurement-based approach is to perturb the original system's input and record the output data. From either the time-domain data or the frequency-domain data, the input/output plant model can be found.

For example, in a power system stabilizer design, the plant model has an input as the reference order of the voltage regulator and the output as the generator speed. The input can be perturbed with an impulse signal, and the output response will be recorded. Subspace methods, e.g., the eigensystem realization algorithm, may be used to process the output data and lead to a reduced-order plant model. Based on the plant model, a controller modulating the voltage regulator's reference with the generator speed as the input can be designed and tested for the closed-loop system performance.

The eigensystem realization algorithm can be traced back to the seminal state space model realization theory established by Ho and Kalman in the 1960s. The core message of the theory is that the dynamic response data can be stacked properly to form a data Hankel matrix. This data Hankel is associated with the state-space model's system matrices. Factorizing the Hankel matrix via singular value decomposition leads to the system matrices. From there, a state-space model that matches the input and output relationship can be recovered. Furthermore, with the system matrices known, the eigenvalues of the system are also known. This feature has been used in the fifth application: PMU data-based oscillation mode identification. This algorithm can be viewed as an inference algorithm of unsupervised learning that relates data to a model and has the capability of filtering out noise using singular value decomposition.

This application of reduced-order model identification is black-box model identification. Here, the input/output relationship is identified. The internal model structure is still unknown.

Admittance model identification for subsynchronous resonance screening. Stability analysis via frequency-domain models has a history dating back to the 1970s in both power electronics and power systems communities. In the power electronics community, the initial use of impedance models for DC circuit stability analysis started in 1976. In the power systems community, dq admittance-based subsynchronous resonance stability analysis also started in the 1970s after the Mohave power plant subsynchronous resonance events in Nevada. For these events, a synchronous generator radially connected to a series compensated line experienced oscillations in its torque shaft, causing shaft damage. The torsional oscillations were triggered by the electric network resonance due to the interaction of the series capacitor and the line inductance. When the frequency of the electric network resonance is complementary to the frequency of a torsional model, i.e., the sum of the two frequencies is 60 Hz, torsional oscillations may become severe.

Compared to the DC circuit analysis dealing with a single-input and single-output system, stability analysis in power systems usually involves three-phase systems. Modeling a three-phase system in a rotating dq-frame can greatly simplify the resulting model. Indeed, one of the most influential modeling technologies of power systems is Park's transformation, which converts variables in the ABC frame to those in the rotor dq-frame. As a result, a synchronous generator model is expressed from the perspective of the rotating rotor frame. Besides generators, other components of the power systems may also be expressed in a dq frame for simplicity. Thus, dq-frame models are preferred in stability analysis. For subsynchronous resonance analysis, a circuit of a generator with series-compensated interconnection can be converted to a two-input and two-output feedback system. The forward unit is the line's admittance in the dq frame, while the feedback unit is the generator's impedance in the dq frame. Stability analysis can then be carried out by examining the feedback system via well-established multi-input and multi-output frequency-domain system analysis theories.

To obtain the generator and network impedance from computer simulation, frequency scans have since been popularly used in subsynchronous resonance studies. Recently, frequency scans have been used in wind farm subsynchronous resonance screening in electromagnetic transient simulation software environments by the grid operating industry. In the power electronics field, obtaining dq impedance/admittance frequency-domain measurement through hardware setup, perturbation signal injection, and measurement processing has been a research topic.

Frequency scans lead to frequency-domain measurement. A benefit of frequency-domain measurement is its use for stability analysis. Either open-loop system Bode plots or Nyquist plots can be plotted and stability prediction can be made. On the other hand, those diagrams have disadvantages compared to closed-loop system eigenvalues. An eigenvalue, in the form of a complex number, gives a direct indication of the stability of a dynamic system. The real part of an eigenvalue must be less than zero for a system to be stable, and the imaginary part of an eigenvalue implicates the oscillation frequency. Thus, eigenvalues directly tell if the system is stable or not and what the system's oscillation modes are. For subsynchronous resonance stability analysis, a generator or transmission system's frequency-domain admittance/impedance measurements have to be fitted into a model in the form of a transfer function matrix. From there, eigenvalue calculation is possible. In fact, though it seems trivial to arrive at eigenvalues after obtaining the admittance measurements of subsystems, it is to be noted that the frequency-domain data fitting technology was not available in the 1970s. This technology is available only after 2000. Without frequency-domain data fitting, it is difficult to identify models and compute eigenvalues from measurements.

This application of admittance model identification is to identify a black-box model describing the terminal voltage and current relationship only. The resulting model does not lead to further information on the generator model structure.

Gray-Box Model Identification. Finding reduced-order models for control design and finding dq admittance for SSR stability analysis are related to identifying black-box models from measurement data. Those models describe the input/output relationship only. The internal structure and parameters of the system under investigation are not imposed as for a gray-box model. The technology of black-box model identification is mature as we have seen real-world applications in these areas. The black-box models are all linear models.

On the other hand, gray-box model identification is actively under investigation. The first two applications—identifying generator reactance and time constants and identifying parameters for load modeling—belong to the category of gray-box model identification. For those applications, prior knowledge of internal physics must be combined with measurement-based learning to achieve the goal of model identification. The models can be nonlinear.

The main issue of gray-box identification is that measurement data may not contain sufficient information on parameters. This can lead to ill-conditioned estimation problems. If this is the case, the estimation problem can be formulated to estimate a subset of the parameters. Algorithm-wise, convergence and local optimum are the main issues for nonlinear optimization problems. For parameter estimation, local optimum means the identified parameters may be far from the true parameters. The resulting estimated output may have a poor matching degree with the measured output. Therefore, many efforts have been devoted to refining the optimization problem formulation.

Optimization is one of the key technologies in gray-box identification. A significant achievement in recent years is the adoption of convex programming techniques in optimization problem formulation and solving. A benefit of convex optimization is that the solution to a convex optimization problem is the global optimum, i.e., the identified parameters are guaranteed to lead to the best match.

IBR modeling. For IBRs, dq admittance measurement technology is a mature technology. The measurement capability can be realized in software as well as hardware experiments with the availability of advanced high-power converters and medium-voltage sensors.

IBR models structure design. In the past decade, a set of generic models for IBRs have been developed by the Western Electricity Coordinating Council's model validation subcommittee for grid dynamic assessment. These models are suitable for power system transient simulation studies with numerical integration time steps in the range of 1 to 5 milliseconds. Such models are based on quasi-steady-state positive-sequence phasors and usually do not include fast electromagnetic transient dynamics and fast inverter current controls.

To have models accommodating a wide range of operating conditions, including unbalanced, fast dynamics, and weak grid conditions, IBR models, including electromagnetic transients and fast controls, are desired. For the grid industry, this is an ongoing research and development area. For example, the CIGRE C4.60 working group aims to design generic electromagnetic transient models of IBRs with transparent IBR control structures.

Because state variables are time-varying at the fundamental frequency in the ABC domain, it is very difficult to derive linear models in the ABC frame. Linear time-invariant models are preferred since they are suitable for small-signal analysis. Therefore, modeling efforts are required to convert a model in an ABC frame to a model with its state variables constant at a steady state. This type of nonlinear model can be easily linearized via numerical methods for linear time-invariant model extraction.

Besides the aforementioned technical challenges in modeling, another significant technical gap of designing transparent models is that the IBR controls are proprietary information of OEM. Strict nondisclosure requirements are imposed by OEMs, which makes any model design a challenging task.

Thus, there are benefits to efforts to standardize IBR control to better define their dynamics and support gray-box modeling. Currently, there are ongoing efforts in the grid industry, e.g., the IEEE P2800 working group aiming to set up the minimum technical requirements for IBRs.

### CONCLUSION

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, are hereby incorporated by reference in their entirety herein.
[1] L. Fan and Z. Miao, “Admittance-based stability analysis: Bode plots, nyquist diagrams or eigenvalue analysis?,” IEEE Trans. Power Syst., vol. 35, no. 4, pp. 3312-3315 July 2020.
[2] L. Fan, Z. Miao, S. Shah, P. Koralewicz, V. Gevorgian, and J. Fu, “Datadriven dynamicmodeling in power systems: Afresh look on inverter-based resource modeling,” IEEE Power Energy Mag., vol. 20, no. 3, pp. 64-76, May/June 2022.
[3] L. Ljung, System Identification: Theory for the User, 2nd ed. Hoboken, NJ, USA: Prentice Hall, 1999.
[4] A. Riccobono, M. Mirz, and A. Monti, “Noninvasive online parametric identification of three-phaseACpower impedances to assess the stability of grid-tied power electronic inverters in LV networks,” IEEE Trans. Emerg. Sel. Topics Power Electron., vol. 6, no. 2, pp. 629-647, June 2018.
[5] L. Fan, Z. Miao, P. Koralewicz, S. Shah, and V. Gevorgian, “Identifying DQ-domain admittance models of a 2.3-MVA commercial grid-following inverter via frequency-domain and time-domain data,” IEEE Trans. Energy Convers., vol. 36, no. 3, pp. 2463-2472 September 2021.
[6] Z. Shen, M. Jaksic, P. Mattavelli, D. Boroyevich, J. Verhulst, and M. Belkhayat, “Three-phase AC system impedance measurement unit (IMU) using chirp signal injection,” in Proc. IEEE 28th Annu. Appl. Power Electron. Conf. Expo., 2013, pp. 2666-2673.
[7] B. Miao, R. Zane, and D. Maksimovic, “System identification of power converters with digital control through cross-correlation methods,” IEEE Trans. Power Electron., vol. 20, no. 5, pp. 1093-199 September 2005.
[8] S. Hadavi, D. B. Rathnayake, G. Jayasinghe, A. Mehrizi-Sani, and B. Bahrani, “A robust exciter controller design for synchronous condensers in weak grids,” IEEE Trans. Power Syst., vol. 37, no. 3, pp. 1857-1867 May 2022.
[9] L. Fan and Z. Miao, “Time-domain measurement-based dq-frame admittance model identification for inverter-based resources,” IEEE Trans. Power Syst., vol. 36, no. 3, pp. 2211-2221 May 2021.
[10] C. Bauer, R. Freeman, T. Frenkiel, J. Keeler, and A. Shaka, “Gaussian pulses,” J. Magn. Reson., vol. 58, no. 3, pp. 442-457, 1984.
[11] Z. Liu, J. Liu, and Z. Liu, “Analysis, design, and implementation of impulse-injection-based online grid impedance identification with grid-tied converters,” IEEE Trans. Power Electron., vol. 35, no. 12, pp. 12959-12976, December 2020.
[12] L. Bao, L. Fan, and Z. Miao, “Wind farms in weak grids stability enhancement: Syncon or statcom?,” Electric Power Syst. Res., vol. 202, 2022. Art. no. 107623. [Online]. Available: https://www.sciencedirect.com/science/article/pii/S0378779621006040

What is claimed is:

1. A system comprising:
a processor; and
a memory having instructions stored thereon, wherein execution of the instructions by the processor causes the processor to:
receive measurement data acquired in response to an application of a Gaussian pulse excitation signal to a power distribution network by a piece of instrumentation equipment, wherein the power distribution network is coupled to one or more operating inverter equipment; and
determine a dq admittance parametric model for the power distribution network using the measurement data;
wherein the dq admittance parametric model is employed as an indication of system stability, or in a system stability analysis, for the power distribution network and its downstream load or power generating equipment, including the one or more operating inverter equipment.

2. The system of claim 1, wherein the Gaussian pulse excitation signal has a power level of at least 5 percent of a nominal voltage magnitude of the power distribution network at a point of the application of the Gaussian pulse excitation signal.

3. The system of claim 2, wherein the Gaussian pulse excitation signal is treated as a transient by components in the power distribution network.

4. The system of claim 1, wherein the execution of the instructions by the processor further causes the processor to:
output the dq admittance parametric model in a graphical user interface or report to be made accessible for the system stability analysis.

5. The system of claim 1, wherein the applied Gaussian pulse excitation signal has a perturbation frequency of at least between 1 Hz and 100 Hz.

6. The system of claim 1, wherein the dq admittance parametric model is generated in real-time in response to a real-time application of a Gaussian pulse excitation signal to a power distribution network.

7. The system of claim 1, wherein the dq admittance parametric model is generated for non-real-time post-analysis assessment of the power distribution network.

8. The system of claim 1, wherein the measurement data includes a response to an application of a single Gaussian pulse excitation signal to the power distribution network.

9. The system of claim 1, wherein an inverter of a wind turbine is a part of the power distribution network.

10. The system of claim 1, wherein the dq admittance parametric model is generated via a continuous-time transfer function analysis.

11. The system of claim 1 further comprising the instrumentation equipment, wherein the processor and memory are a part of the same.

12. A method comprising:
receiving, by a processor, measurement data acquired in response to an application of a Gaussian pulse excitation signal to a power distribution network by an instrumentation equipment, wherein the power distribution network is coupled to one or more operating inverter equipment; and
determining, by the processor, a dq admittance parametric model for the power distribution network using the measurement data,
wherein the dq admittance parametric model is employed as an indication of system stability, or in a system stability analysis, for the power distribution network and its downstream load or power generating equipment, including the one or more operating inverter equipment.

13. The method of claim 12, wherein the Gaussian pulse excitation signal has a power level of at least 5 percent of a nominal voltage magnitude of the power distribution network at a point of the application of the Gaussian pulse excitation signal.

14. The method of claim 13, wherein the Gaussian pulse excitation signal is treated as a transient by components in the power distribution network.

15. The method of claim 12 further comprising:
outputting the dq admittance parametric model in a graphical user interface or report to be made accessible for the system stability analysis.

16. The method of claim 12, wherein the applied Gaussian pulse excitation signal has a perturbation frequency of at least between 1 Hz and 100 Hz.

17. The method of claim 12, wherein the dq admittance parametric model is generated in real-time in response to a real-time application of a Gaussian pulse excitation signal to a power distribution network.

18. The method of claim 12, wherein the dq admittance parametric model is generated for non-real-time post-analysis assessment of the power distribution network.

19. The method of claim 12, wherein the dq admittance parametric model is generated via a continuous-time transfer function analysis.

20. A non-transitory computer-readable medium having instructions stored thereon, wherein execution of the instructions by the processor causes the processor to:
receive measurement data acquired in response to an application of a Gaussian pulse excitation signal to a power distribution network by a piece of instrumentation equipment, wherein the power distribution network is coupled to one or more operating inverter equipment; and
determine a dq admittance parametric model for the power distribution network using the measurement data;
wherein the dq admittance parametric model is employed as an indication of system stability, or in a system stability analysis, for the power distribution network and its downstream load or power generating equipment, including the one or more operating inverter equipment.
